(19) United States
(12) Patent Application Publication
(10) Pub. No.: US 2025/0156933 A1
(43) Pub. Date: May 15, 2025

(54) Online Marketplace And Methods For Buying And Selling Sustainable And Eco-Friendly Goods And Services

(71) Applicant: David Vitalli, BRENTWOOD, TN (US)

(72) Inventor: David Vitalli, BRENTWOOD, TN (US)

(21) Appl. No.: 18/505,269

(22) Filed: Nov. 9, 2023

(51) Int. Cl. G06Q 30/0601

(52) U.S. Cl. CPC G06Q 30/0641

(57) ABSTRACT

An online marketplace and methods are provided that comprise a user interface that buyers and sellers can access concerning sustainable and/or eco-friendly goods and services for sale that are credentialed (e.g., validated, verified) as being such. Also provided is a navigation aid that facilitates buyers in purchasing sustainable and/or eco-friendly goods and services from the online marketplace.

### FIELD OF THE INVENTION

The invention relates to a particular online marketplace and methods for the buying and selling of sustainable and/or eco-friendly goods and services.

### BACKGROUND OF THE INVENTION

It has been estimated that approximately 80% of consumers seek sustainable and eco-friendly products and brands when shopping. However, there is no organized, credentialed (e.g., validated, verified), relatively fast and easy way for such buyers to identify, learn about, source, and shop for such goods and services. Many of such buyers have indicated that they are willing to pay more for such sustainable and/or eco-friendly goods and services. Buyers generally need to do multiple searches online for such goods and services and may not successfully locate them or they may not pursue such ends because it is too time consuming and difficult. In this manner, the buyers' needs and desires to often, mostly, or even exclusively, buy such goods and services, or at least being provided the option to consider doing so, are not being met.

At the same time, certain sellers are spending more time and resources to develop, market and sell such goods and services, or are considering doing so, even though there are a lack of adequate connections between the needs and desires of buyers for sustainable and/or eco-friendly options and the offerings of sellers regarding these goods and services. Despite this disconnect, these sellers of goods and services have still shown interest in investing in and providing sustainable and eco-friendly goods and services, even if some of these goods and services may cost more for sellers to provide and for consumers to purchase. However, there is no organized, credentialed, fast and easy way for them to present such goods and services to consumers who are interested in such goods and services for purchase that draws attention to them, provides information concerning them, and provides the buyers with access to such goods and services in a credentialed and focused space.

Online marketplaces, such as provided on Amazon.com, Etsy.com, and others, provide for access to various goods and services that can be bought and sold. However, none of these online marketplaces permit the users to easily identify, learn about, see, compare, buy, and/or sell, selections of goods and services that are directed to sustainable and/or eco-friendly choices, or who have access to sellers, goods or services that have been credentialed to provide such in a readily accessible manner.

Therefore, a new online marketplace and methods are needed to provide sellers with vehicles (e.g., websites, navigation aids) to provide information and access to their sustainable and/or eco-friendly goods and services to customers. Such an online marketplace and methods are also needed that the purchasing customers can rely on and trust and use to enhance their shopping experiences and meet their needs and desires for sustainable and/or eco-friendly goods and services.

### SUMMARY OF THE INVENTION

An online marketplace and methods are provided that comprise a user interface that buyers and sellers can access concerning sustainable and/or eco-friendly goods and services for sale that are credentialed (e.g., validated, verified) as being such. Also provided is a browser extension and/or other navigation aid that facilitates buyers in obtaining access to the online marketplace and purchasing sustainable and/or eco-friendly goods and services.

The most preferred online marketplace and methods of this invention have a zero carbon footprint and they are designed to permit each seller their own portal to present their sustainable and/or eco-friendly goods and services through a marketplace designed to minimize logistical complexity and global waste.

Embodiments of this invention are directed to a global online marketplace that provides access to sellers and buyers to present, advertise, identify, be directed to, learn about, compare, sell or purchase sustainable and/or eco-friendly goods and services. The buyers' needs and desires are evaluated using browser extensions and/or other navigation aids, including artificial intelligence, to direct them to sellers and products and services concerning which they may have an interest in learning about and purchasing. The sellers, the products and/or the services undergo to a credentialing (e.g., validation, verification) process to determine whether the sellers, goods and services meet requirements that indicate they are based on sustainable and/or eco-friendly practices or origins. The buyers can therefore rely on the sellers and the goods and services they are purchasing. The sellers can use an outlet that showcases their sustainable and/or eco-friendly practices, goods and services, which may help them recoup or otherwise justify any additional expenses incurred from providing such goods and services, thereby encouraging better sustainable and eco-friendly practices that benefit the planet and everyone that inhabits it.

Preferred embodiments include an “eco navigator” (a non-limiting name used here for reference and exemplary purposes only), which is a browser extension and/or other navigation aid, that empowers buyers to shop with purpose and facilitates making sustainable and/or eco-friendly choices easily. Such an eco navigator uses artificial intelligence to assist shopping and improve the ability to identify, be directed to, learn about, and purchase sustainable and/or eco-friendly goods and services. Specifically, in these embodiments, the eco navigator suggests sustainable and/or eco-friendly sellers, products and services from one or more websites based on a buyers' past or current practices or searches. For example, if a buyer (e.g., potential buyer) has downloaded the eco navigator from the internet and is shopping on the internet for products on virtually any device capable of doing so, the eco navigator will display (e.g., on a pop-up window, on a third party website itself, or otherwise) sustainable and/or eco-friendly products that are similar in terms of the buyer's shopping needs, practices, and habits. The buyer can then chose (e.g., select, double click) to be directed to the online marketplace of this invention to learn more about, compare, or purchase the products.

The eco navigator is obtained (e.g., downloaded from a server associated with an online marketplace of this invention) by the buyer and then it works with the browser (e.g., Chrome, Opera, Brave, Firefox, Safari, UC Browser, Microsoft Edge, Internet Explorer, Yandex Browser, Samsung Internet) to identify, direct, teach, and facilitate the purchase of these products and/or services. In certain of these embodiments, the eco navigator also provides estimates or other information to the buyer regarding how the particular purchase may benefit the environment or health of the user or planet.

The invention can relate to any goods or services, such as those offered in the fashion industry, cosmetics, home goods, furniture, home repair, dry cleaning, home cleaning, car repair, accounting, legal, etc.

Embodiments of this invention include computer executable functions that are stored on a computer device (e.g., a remote server) that run on a user's device such as a smartphone, laptop computer, tablet computer, or desktop computer, or any other device that connects to a computer device over the internet or another network with data that either stores it or processes it to be used on the user's device. Thus, an online marketplace in embodiments of this invention can be stored on one or more computer servers and be accessed by a user's device. Browser navigator extensions, such as the example of such labeled the eco navigator described herein, can be downloaded and used on the user's device also.

Certain preferred embodiments of this invention comprise an online marketplace comprising a user interface, a seller user module, a buyer user module, a credentialing module, and a navigation aid module. In these embodiments, the online marketplace provides for the selling and buying of at least one sustainable and/or eco-friendly good or service that meets a particular standard set by the online marketplace.

In these preferred embodiments of an online marketplace, the online marketplace further comprises (a) a non-transitory machine readable medium embodying a set of computer executable instructions that, in response to being executed by one or more processors, cause performance of operations, the operations comprising providing for the user interface, the seller user module, the credentialing module, the buyer user module, and the navigation aid module, which instructions are located on one or more computer servers that are accessible to at least one seller user and at least one buyer user that each can use at least a portion of the user interface.

In these embodiments of an online marketplace. (b) the seller user module provides for the at least one seller to present seller information concerning the at least one sustainable and/or eco-friendly good or service on the online marketplace user interface. The seller information comprises a description, credentials, and pricing of the good or service. It may include photographs of the goods or that relate to the services. Preferably, the goods ship directly from the sellers. The credentials comprise whether the good or service meets the particular standard set by the online marketplace. These standards are set with respect to the particular seller, good or service in question. In these embodiments, (c) the credentialing module verifies the seller information including the credentials by reviewing the seller information and comparing it to the particular standard set by the online marketplace. It may do so using artificial intelligence to make the comparison in some embodiments.

In these embodiments of an online marketplace, (d) the buyer user module provides for the at least one buyer to access the seller information concerning the at least one sustainable and/or eco-friendly good or service on the online marketplace user interface and to purchase such good or service if desired. The module or another component of the online marketplace may calculate and inform the buyer of what is being saved in the green sector, such as plastics, paper, and emissions by drop shipping directly from the seller to the buyer, or other advantages from the goods, services, or the seller itself. As the sale is made, the module or another component of the online marketplace calculates the percentage of what the marketplace earns as a commission or other fee and notifies the seller of where their nearest store or warehouse is located and then facilitates the shipment of the goods directly from the warehouse to the buyer, resulting in no extra warehousing or packaging once the good leaves the seller.

In these embodiments, (e) the navigation aid module is available to the at least one buyer to use and it directs the buyer to the online marketplace if the buyer provides an interest in the at least one sustainable and/or eco-friendly good or service or a similar good or service. The navigation aid module uses artificial intelligence to recognize the buyer's interest in the at least one sustainable and/or eco-friendly good or service. The artificial intelligence may also capture and analyze information concerning the buyer and the buyer's online presence and make predictions and/or provide guidance to particular goods and services the buyer may be interested in purchasing or learning about. The artificial intelligence may also give the buyer better sustainable and/or eco-friendly choices found on the online marketplace and give them, in real time, updates on their browsers, in their texts, in their email, etc., concerning more green goods and services that are aligned with the buyer's shopping habits and interests.

Other preferred embodiments of this invention comprise a method of providing an online marketplace for sustainable and/or eco-friendly goods and services to at least one seller and at least one a buyer. The method comprises (a) providing access to the seller and the buyer to a non-transitory machine readable medium embodying a set of computer executable instructions that, in response to being executed by one or more processors, cause performance of operations, the operations comprising providing for a user interface, a seller user module, a credentialing module, a buyer user module, and a navigation aid module, which instructions are located on one or more computer servers that are accessible to at least one seller user and at least one buyer user that each can use at least a portion of the user interface.

These method embodiments also comprise (b) uploading seller information to the seller user module by the seller using the user interface, the seller information comprising a description, credentials, and pricing of the sustainable and/or eco-friendly goods and services. These embodiments also comprise (c) verifying the credentials in the seller information using the credentialing module. The verifying further comprises comparing the seller information to a particular standard set by the online marketplace. This step may use artificial intelligence and/or manual review by the online marketplace to conduct or assist the verification.

These method embodiments also comprise (d) responding to a request to provide the seller information to the user interface. The request is made by the buyer using the buyer user module. These embodiments also comprise (e) directing the buyer to the online marketplace using the navigation aid module in response to a detection of the buyer expressing interest in the seller, the sustainable and/or eco-friendly goods and services, or similar goods or services. This detection of interest comprises using artificial intelligence to recognize the buyer's interest.

Advantages to sellers include the dissemination of information concerning their goods and services and practices, and access to buyers to such goods and services, which may include a better return on investment with their sustainable and eco-friendly goods and services because embodiments of this invention increase the chance of joining interested buyers with the seller's sustainable and/or eco-friendly goods and services and information regarding such.

Advantages to buyers include an easier place to find sustainable and/or eco-friendly goods and services they are interested in purchasing, reducing the time and difficulty in locating such potential purchases. Buyers may also feel better about their choices, and be more informed, and understand that they are not just a passive presence, but are doing something about making and encouraging improvements.

Advantages to everyone including both sellers and buyers and even those beyond them, include increasing the benefits of investing in sustainable and eco-friendly goods and services, which will increase their availability, and reduce the occurrence of harmful or detrimental activities associated with other goods and services that are not sustainable or eco-friendly. This will help the environment and the world as a whole, and protect the planet. Validation and credentialing of sellers and their goods and services will reduce the chance of untruthful and/or fraudulent statements regarding goods and services and encourage competition and efforts in beneficial endeavors.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a flowchart of an embodiment of an online marketplace of the invention.

### DETAILED DESCRIPTION OF THE INVENTION

The invention provides a new online marketplace and methods for the presentation, advertisement, shopping, information providing, marketing and sales of sustainable and/or eco-friendly goods and services. “Sustainable” as used herein overlaps with “eco-friendly” and “green” and means the manufacturing, harvesting, use, practice, marketing, selling, and/or buying of goods or services to attempt to reduce or eliminate the use of relevant resources and damage to such. “Eco-friendly” overlaps with “sustainable” and “green” and means the manufacturing, harvesting, use, practice, marketing, selling, and/or buying of goods or services to attempt to reduce or eliminate the effects (e.g., harm, disruption) on the relevant environment.

### Embodiments of the Online Marketplace

This invention includes an online marketplace for sustainable and/or eco-friendly goods and services. The online marketplace can comprise computer executable instructions stored on one or more computer servers. The online marketplace can also comprise one or more modules, which are described herein as separate modules, but one of skill in the art will understand that each of these modules can be combined with one or the other or all together or otherwise be separated into separate components in different modules and thus it is their functions that are important and not their description as being in separate or particular modules, which are described in this manner herein only for purposes of clarity and communication and thus should not be considered as limiting the invention in any way.

These modules of the online marketplace can include a user interface module, a credentialing module, a seller user module, a buyer user module, and a navigation aid module, among others, although additional modules can be used. Each of these modules is part of the facilitation of the offering and selling of sustainable and/or eco-friendly goods and services by the embodiments of this invention.

In certain embodiments of this invention, the user of the embodiments collaborates with brands (i.e., particular sellers) that resonate deeply with the actual and desired customers, including brands the buyers may recognize and hold in high esteem. This spectrum spans from luxury icons to smaller yet essential household names. Paramount among the principles to be applied, however, is an unwavering commitment to sustainability, which is in some ways an elusive concept in today's business landscape, where every entity strives to present its most commendable face.

In this context, a critical part of preferred embodiments of this invention is the validation and upholding of the brands' accountability for their sustainable endeavors. While a handful of modest organizations have attempted to measure this, the optimal approach lies in establishing proprietary sustainability credentials. This pursuit serves a dual purpose. Foremost, it empowers one to prevent the deceptive practice of “greenwashing,” where brands merely present a facade of sustainability to cater to their customer base. The aim of these embodiments is to curate products that epitomize utmost sustainability, crafted using the most eco-friendly materials possible in collaboration with brand partners.

Secondly, by formulating a proprietary (e.g., by the online marketplace or adopted from others) benchmark for sustainability, one can meet brands at various points along their unique sustainability journeys. This adaptive approach is paramount in fostering the transformative change one can aspire to witness in companies endeavoring towards a brighter future. A noteworthy principle is that this process in some embodiments is open to all brands, even if their practices are not yet aligned with all of the credentialing standards. As long as a brand demonstrates a willingness to embark on the path toward a better future, in these embodiments the user stands ready to collaborate to encourage such behavior.

In certain embodiments of this invention another important component (e.g., function, feature, component, module) is a navigation aid (e.g., eco navigator) that the buyer can choose and implement as much as they desire. For example, a browser extension embodiment of this invention may provide pop-up windows if a need or desire or interest is shown by the buyer in a particular seller or sustainable and/or eco-friendly good or service in searching behavior. The navigation aid may also provide suggestions on check-out windows before purchases are made. A person of skill in the art will be aware of other possible applications of such navigation aids to a buyer's experiences with particular computer devices. The navigation aid's overall function, however, will be to facilitate a buyer's interest in sellers and goods and services that are sustainable and/or eco-friendly.

Advantage of certain embodiments of this invention can include the use of less shipping materials. According to Canopy, the forest conservation group, an estimated 3 billion trees are pulped yearly to produce 241 million tons of shipping cartons. Of the 86 million tons of plastic packaging produced globally each year, less than 14% is recycled.

Additionally, the transport of goods across the world is responsible for a huge portion of CO₂ emissions generated by e-commerce. In 2020, the shipping and return of products accounted for 37% of the total GHG emissions, though today the number is thought to be higher.

With these stats in mind, embodiments of this invention are advantageous for brands, helping them reduce their global impact significantly with a no warehousing system. These embodiments may boast reducing emissions of the commerce process by up to 50% and manpower up to 85%.

Major online marketplace and commerce sites like Amazon create a massive carbon footprint by repackaging, transporting and storing even their third party products. This results in massive amounts of plastic, manpower and emissions that, given these embodiments, is unnecessary. By eliminating excessive warehousing, repackaging, manpower, and added transportation, these embodiments can reduce or eliminate the carbon footprint that goes along with the business and create real change not just for those that practice these embodiments, but for brand partners as well.

### Seller Users Of The Online Marketplace

Embodiments of this invention will provide seller access to the online marketplace to offer their goods and services. This access can be provided in the form of a seller user module or some other form. The seller can access (e.g., through a user interface) a portion of the online marketplace and provide information about themselves and their goods and/or services. This information can also include information concerning their sustainability and/or eco-friendly practices, product description, pricing, etc. This information can also include information concerning their credentials provided by the online marketplace concerning themselves and/or their goods or services. These credentials and how they are obtained are described further below.

In certain embodiments, sellers may provide their products for sale on an ecoshop (as an example of an online marketplace) and the products will be sold to the buyer at a mark-up (e.g., the seller gets wholesale price while ecoshop gets the additional amount for the retail price). In certain embodiments, the seller takes care of all manufacturing, warehousing, packaging, transportation, shipping, handling, etc., and the ecoshop has a net-zero carbon footprint.

Shops such as an ecoshop example provided herein may also obtain advertisement revenue from sellers advertising their goods and services on the site with vehicles such “sponsored” banners and thumbnails, as well as from increasing brand awareness and educational advertisements. In some embodiments, partnerships can be offered in order to secure distribution on a site. For example, in these embodiments, the user of this invention could own a percentage (e.g., 33%) of the seller and distribute a product as an “in-house” brand.

Credentialing of the Goods and Services with Certain Embodiments

Credentialing is the process of assessing the qualifications and practices of a seller and the goods or services they provide (e.g., validation, verification). The credentials can be provided by the credentialing module that compares the description of the seller and/or the sustainable and/or eco-friendly goods and services with a standard set by the online marketplace. If the standards are met, the online marketplace and/or the credentialing module can issue credentials. The online marketplace in some embodiments can provide independent checking and verification of the information either manually or this can be provided using artificial intelligence or other techniques that verify and check information.

The standard can include any applicable characteristics including environmental impact, sustainable use of resources, harmfulness to the environment, carbon footprint, pollution, and other factors applicable to the sellers (e.g., manufacturing impact on the environment), goods (e.g., carbon footprint from manufacture or use), or service (e.g., pest removal's use of natural chemicals). The standard can have different grades that are met, indicating how much effort the seller is using. In some embodiments, this may be reflected in a sliding scale that recognizes efforts such as poor, good, better, and best, and other grades known to a person of skill in the art that indicate the relative or comparative sustainability and/or eco-friendliness of a good or service.

### Buyer Users Of The Online Marketplace

Embodiments of this invention will provide buyer access (e.g., through a user interface) to the online marketplace to locate, learn about, and purchase sustainable and/or eco-friendly goods and services. This access can be provided in the form of a buyer user module or some other form. The buyer can access a portion of the online marketplace and provide information about themselves and their needs or desires for particular goods and/or services. This information can also include information concerning their needs or desires for sustainability and/or eco-friendly practices, product descriptions, pricing, etc.

In certain embodiments, buyers can access information concerning sellers and their products for sale on an ecoshop (as an example of an online marketplace) and the products will be sold to the buyer at a mark-up (e.g., the seller gets wholesale price while ecoshop gets the additional amount for the retail price). In certain embodiments, the seller takes care of all manufacturing, warehousing, packaging, transportation, shipping, handling, etc., and the ecoshop has a net-zero carbon footprint.

Shops such as an ecoshop example provided herein may also obtain advertisement revenue from sellers advertising their goods and services on the site with vehicles such “sponsored” banners and thumbnails, as well as from increasing brand awareness and educational advertisements. In some embodiments, partnerships can be offered in order to secure distribution on a site. For example, in these embodiments, the user of this invention could own a percentage (e.g., 33%) of the seller and distribute a product as an “in-house” brand.

Features such as comparative shopping information and the benefits of a product or service to reduce carbon footprint or other benefits may be provided to the buyer.

### Navigation Aids Provided With Certain Embodiments

Internet browsers provide an intuitive interface for navigating the internet. One can enter a website's address (URL) directly into the address bar, and the browser will take the person to that specific webpage. Additionally, one can click on hyperlinks within web pages to navigate to other related pages. Browsers also support bookmarks, which allow one to save and organize frequently visited websites for quick access.

The front-end of a browser refers to the user-facing part that the user interacts with. It includes the graphical user interface (GUI) elements, such as the address bar, navigation buttons, bookmarks, and tabs. The front-end also handles the rendering of web pages, displaying the content, images, and interactive elements on your device's screen. The back-end of a browser encompasses the complex processes that occur behind the scenes. It handles the communication between the browser and web servers, fetching and managing web page resources, and processing the code that makes up the web pages. The back-end interprets HTML, CSS, and JavaScript files, ensuring that web pages are rendered correctly. It manages network connections, supports various protocols like HTTP and HTTPS, and handles security measures such as encryption and certificate verification.

Certain embodiments of this invention use a browser navigator extension and/or other navigation aid that adds features and functions to a browser. It can be created using web-based technologies—HTML, CSS, and JavaScript and it can take advantage of the same web APIs as JavaScript on a web page, and also have access to its own set of JavaScript APIs. Certain of these embodiments enhance or complement third party websites to deliver additional in-browser features or information from the online marketplace website to allow the collection of details from pages that are visited to enhance the services that are offered.

Preferred embodiments of the browser navigator extensions and other navigation aids are in the form of modules comprised of computer executable instructions. They add new features with flexible user interface options and the power of WebExtensions API's to add such new features to a buyer's browser to refer the buyer to an online marketplace of this invention, including the sustainable and/or eco-friendly goods and services or sellers that are offered there. The most preferred embodiments use artificial intelligence within the navigation aid modules to analyze the buyer's searching habits and interests to recommend and refer to the online marketplace of this invention and the sustainable and/or ecofriendly goods and services that are offered there.

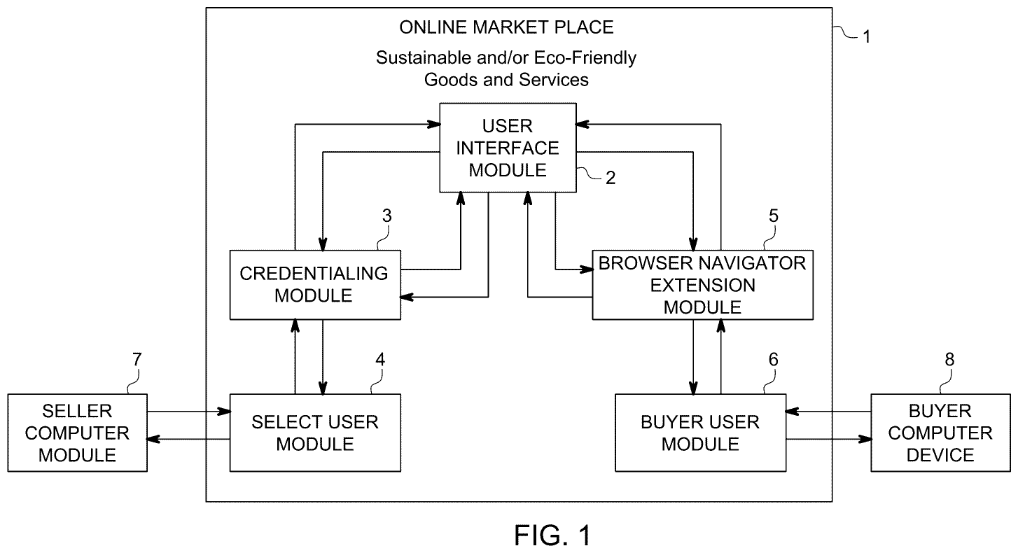

FIG. 1 shows a flowchart of an embodiment of this invention including an online marketplace 1 for sustainable and/or ecofriendly goods and services.

The online marketplace 1 of this embodiment of FIG. 1 comprises a user interface 2 that can interact with a seller user module 4 and/or a credentialing module 3 that itself interacts with the seller user module 4. A seller computer device 7 can interact with the seller user module 4 using the seller's computer device 7 (e.g., mobile phone, laptop, tablet, desktop) and the internet to provide seller information to the user interface 2. The seller information can comprise descriptions, credentials, and pricing information concerning sustainable and/or eco-friendly goods and services. The credentials can be provided by the credentialing module 3 that compares the description of the sustainable and/or eco-friendly goods and services with a standard set by the online marketplace 1 and issues credentials if the standard is met. The online marketplace in some embodiments can provide independent checking and verification of the information provided using artificial intelligence or other techniques.

The standard can include any applicable characteristics including environmental impact, sustainable use of resources, harmfulness to the environment, carbon footprint, pollution, etc. The standard can have different grades that are met, such as a sliding scale that recognizes effort such as poor, good, better, and best, and other grades known to a person of skill in the art that indicate the relative or comparative sustainability and/or eco-friendliness of a good or service or seller.

The online marketplace 1 of this embodiment shown in FIG. 1 also comprises a user interface 2 that can interact with a buyer user module 6 and/or a browser navigator extension module 5 (e.g., a specific embodiment of a navigation aid module) that itself interacts with the buyer user module 6. A buyer computer device 8 can interact with the buyer user module 6 using a buyer computer device 8 (e.g., mobile phone, laptop, tablet, desktop) and the internet to provide buyer information to the user interface 2 and also access the seller information that can comprise descriptions, credentials, and pricing information concerning sustainable and/or eco-friendly goods and services or sellers.

The online marketplace 1 of this embodiment can also provide a browser navigator extension to the buyer through the browser navigator extension module 5 that can interact with the buyer's computer device 8 to refer the buyer to the online marketplace user interface 2 if the buyer expresses interest in a seller or a sustainable and/or eco-friendly good or service offered on the user interface 2. The browser navigator extension module 5 can use artificial intelligence to detect a buyer's possible interest in a seller or a sustainable and/or eco-friendly good or service.

### Particular Applications To Computer Devices

The online marketplace and methods applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment. program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. An online marketplace comprising a user interface, a seller user module, a buyer user module, a credentialing module, and a navigation aid module, the online marketplace providing for the selling and buying of at least one sustainable and/or eco-friendly good or service that meets a particular standard set by the online marketplace, the online marketplace further comprising:
(a) a non-transitory machine readable medium embodying a set of computer executable instructions that, in response to being executed by one or more processors, cause performance of operations, the operations comprising providing for the user interface, the seller user module, the credentialing module, the buyer user module, and the navigation aid module, which instructions are located on one or more computer servers that are accessible to at least one seller user and at least one buyer user that each can use at least a portion of the user interface;
(b) the seller user module that provides for the at least one seller to present seller information concerning the at least one sustainable and/or eco-friendly good or service on the online marketplace user interface, the seller information comprising a description, credentials, and pricing of the good or service, the credentials comprising information concerning whether the good or service meets the particular standard set by the online marketplace;
(c) the credentialing module that verifies the seller information including the credentials by reviewing the seller information and comparing it to the particular standard set by the online marketplace
(d) the buyer user module that provides for the at least one buyer to access the seller information concerning the at least one sustainable and/or eco-friendly good or service on the online marketplace user interface and to purchase such good or service if desired; and
(e) the navigation aid module that is available to the at least one buyer to use and that directs the buyer to the online marketplace if the buyer provides an interest in the at least one sustainable and/or eco-friendly good or service, the bowser navigator extension module using artificial intelligence to recognize the buyer's interest in the at least one sustainable and/or eco-friendly good or service.

2. The online marketplace of claim 1, wherein the navigation aid module comprises a browser navigator extension.

3. A method of providing an online marketplace for sustainable and/or eco-friendly goods and services to a seller and a buyer, the method comprising;
(a) providing access to the seller and the buyer to a non-transitory machine readable medium embodying a set of computer executable instructions that, in response to being executed by one or more processors, cause performance of operations, the operations comprising providing for a user interface, a seller user module, a credentialing module, a buyer user module, and a navigation aid module, which instructions are located on one or more computer servers that are accessible to at least one seller user and at least one buyer user that each can use at least a portion of the user interface,
(b) uploading seller information to the seller user module by the seller using the user interface, the seller information comprising a description, credentials, and pricing of the sustainable and/or eco-friendly goods and services;
(c) verifying the credentials in the seller information using the credentialing module, the verifying further comprising comparing the seller information to a particular standard set by the online marketplace;
(d) responding to a request to provide the seller information to the user interface, the request by the buyer using the buyer user module; and
(e) directing the buyer to the online marketplace using the navigation aid module in response to a detection of the buyer expressing interest in the seller or the sustainable and/or eco-friendly goods and services, the detection comprising using artificial intelligence to recognize the buyer's interest.

4. The method of claim wherein the navigation aid module comprises a browser navigator extension.
